(19) United States
(12) Patent Application Publication
(10) Pub. No.: US 2015/0067827 A1
(43) Pub. Date: Mar. 5, 2015

(54) APPARATUS AND METHOD FOR SETTING A USER-DEFINED PATTERN FOR AN APPLICATION

(71) Applicant: Pantech Co., Ltd., Seoul (KR)

(72) Inventors: Hun-Il LIM, Seoul (KR); Sung-Tae KIM, Seoul (KR)

(21) Appl. No.: 14/473,177

(22) Filed: Aug. 29, 2014

(30) Foreign Application Priority Data
Aug. 29, 2013 (KR) 10-2013-0103415

(51) Int. Cl. G06F 21/32

(52) U.S. Cl. CPC G06F 21/32
USPC 726/19

(57) ABSTRACT

Provided is a terminal with a fingerprint reader and method of operating the same. The terminal includes a fingerprint reader to scan and read a fingerprint of a user and a user verification module. The user verification module calculates a matching value between the fingerprint read by the fingerprint reader and a previously registered fingerprint of the user, and identifies the matching value and a security level of a requested application to determine whether to execute the requested application. The security level is variable; for example, the security level may vary according to a type of application or may be arbitrarily set by the user.

### CROSS-REFERENCE TO RELATED APPLICATION

This application claims priority from and the benefit under 35 U.S.C. §119(a) of Korean Patent Application No. 10-2013-0103415, filed on Aug. 29, 2013, which is hereby incorporated by reference for all purposes as if fully set forth herein.

### BACKGROUND

1. Field

Exemplary embodiments of the present invention relate to a terminal, and more particularly, to a terminal with a fingerprint reader and a method of operating the terminal.

2. Discussion of the Background

Recently, mobile computing devices or smart mobile devices (hereinafter simply referred to as “mobile terminals”), such as smartphones or tablet computers, each with a mobile operating system (OS) mounted thereon, are being widely used. The development of information technology (IT) has continuously improved hardware performance of mobile terminals, and extensive digital convergence enables various hardware modules to be integrated into mobile terminals. Users can enjoy various hardware modules installed in mobile terminals and may install many application programs in their mobile terminals for various usages and purposes.

One example of hardware modules that may be integrated into the mobile terminal is a fingerprint reader. The fingerprint reader is a device that reads a user's fingerprint scanned using a fingerprint scanner. The fingerprint reader may be used as a tool to verify a user of the mobile terminal. More specifically, it is determined whether the fingerprint read by the fingerprint reader matches a previously registered fingerprint by comparing them, thereby enabling a determination whether the user of the fingerprint is an authenticated user or not. For user verification of a mobile terminal, a fingerprint may be used alone, or in combination with other verification operations (e.g., password verification operation).

The general mobile terminal's user verification process using a fingerprint reader is not significantly different from user verification process configured for an entrance building door or a fixed device (e.g., a safe or an automatic teller machine). This is because a typical fingerprint reader is simply applied to a mobile terminal. However, it may not be appropriate to apply the existing user verification process to a mobile device, since the correctness of fingerprint recognition and the fingerprint verification result determined by the conventional configurations may vary depending on an environment where a user is situated or a method how the user uses the mobile terminal. For example, apart from the case where the user puts the mobile terminal on a table or a desk and scans the fingerprint, it may be difficult to correctly recognize the fingerprint with a fingerprint reader equipped in the mobile terminal when the user holds the mobile terminal with one hand and scans a fingerprint of another hand (or the same hand). Thus, an error is likely to occur in a user verification process using the recognized fingerprint. If the requirements for the fingerprint verification are loosened so as to prevent or reduce user verification errors, effects of the secured verification may be reduced. Especially, since a mobile terminal does not only store personal information but also may be being used for financial transactions, it may not be desirable to loosen the requirement for the security verification.

The above information disclosed in this Background section is only for enhancement of understanding of the background of the invention and therefore it may contain information that does not form any part of the prior art.

### SUMMARY

Exemplary embodiments of the present invention relate to a terminal, and more particularly, to a terminal with a fingerprint reader and a method of operating the terminal.

Additional features of the invention will be set forth in the description which follows, and in part will be apparent from the description, or may be learned by practice of the invention.

Exemplary embodiments of the present invention provide a method that uses a processor to control a fingerprint authentication operation of a mobile device, the method including: recognizing a fingerprint if an object touches a designated location of the mobile device; determining one or more authentication parameters to authenticate the recognized fingerprint, the one or more authentication parameters being varied according to one or more defined factors; retrieving a registered fingerprint to authenticate the recognized fingerprint; and authenticating, using the processor, the recognized the fingerprint based on the one or more variable parameters.

Exemplary embodiments of the present invention provide a mobile device to control a fingerprint authentication operation, the mobile device including: a fingerprint reader to recognize a fingerprint if an object touches a designated location of the mobile device; and a processor to determine one or more authentication parameters to authenticate the recognized fingerprint, the one or more authentication parameters being varied according to one or more defined factors, to retrieve a registered fingerprint to authenticate the recognized fingerprint, and to authenticate the recognized the fingerprint based on the one or more variable parameters.

Exemplary embodiments of the present invention provide a non-transitory computer-readable storage medium having stored thereon computer executable instructions for authentication of a fingerprint, the stored computer executable instructions configured to cause a processor to perform processes including: recognizing a fingerprint if an object touches a designated location of the mobile device; determining one or more authentication parameters to authenticate the recognized fingerprint, the one or more authentication parameters being varied according to one or more defined factors; retrieving a registered fingerprint to authenticate the recognized fingerprint; and authenticating, using the processor, the recognized the fingerprint based on the one or more variable parameters.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a mobile device with a fingerprint reader according to an exemplary embodiment of the present invention.

FIG. 2 illustrates an example of fingerprint registration procedures.

FIG. 3A is a diagram illustrating a ridge ending of a fingerprint.

FIG. 3B is a diagram illustrating a ridge bifurcation of a fingerprint.

FIG. 4 is a flowchart illustrating user verification procedures according to an exemplary embodiment of the present invention.

FIG. 5 is a flowchart illustrating a security level setting procedure after a new application has been installed in a mobile device according to an exemplary embodiment of the present invention.

FIG. 6 is a flowchart illustrating a security level setting procedure by setting a security level setting menu provided by a settings application installed in a mobile device according to an exemplary embodiment of the present invention.

FIG. 7A is a diagram illustrating an example of a security level database (DB) when a security level is set on an application-by-application basis.

FIG. 7B is a diagram illustrating an example of a security level DB when a security level is set based on an application type.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

In the following description, exemplary embodiments will be provided with a focus on a mobile device, such as a smart phone, a smart pad, a tablet computer, or the like; however, the technical concepts of the embodiment may be applied not only to the mobile devices but also to other devices, such as a personal computer.

In addition, operations of a mobile terminal, such as, “unlocking,” “execution of function,” and “execution of application,” that are determined to be executed using fingerprint verification will be simply referred to as “execution of application.” It will be understood that the language “execution of application” implies all the above terms, as long as it is not against an explicit expression or common knowledge well known to one of ordinary skilled in the art.

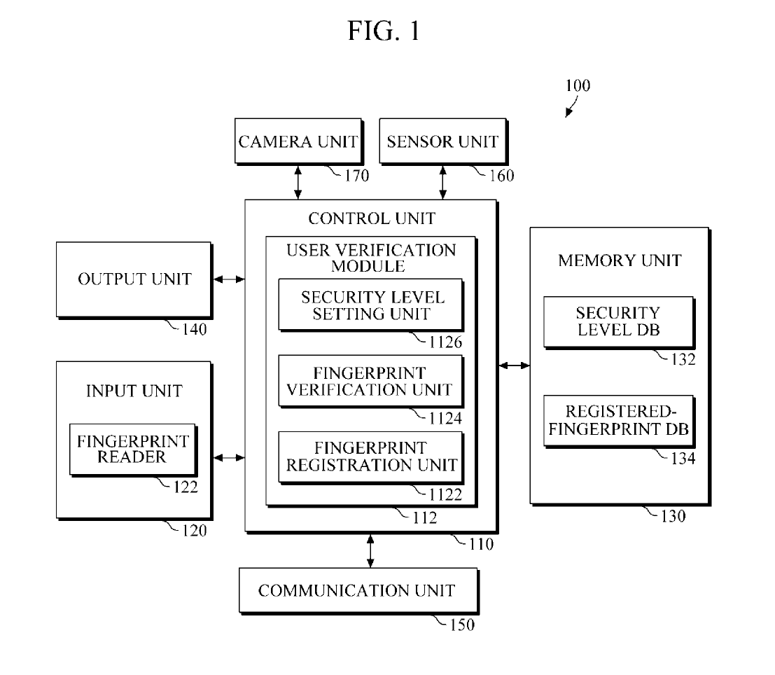

FIG. 1 is a block diagram illustrating a mobile device with a fingerprint reader according to an exemplary embodiment of the present invention. Referring to FIG. 1, the mobile device 100 is equipped with a predetermined mobile operating system (OS), which allows various applications to be installed and run in the mobile device 100. The mobile device 100 may be a smart phone or a table computer, but it is not limited thereto. For example, the mobile device 100 may be a personal multimedia player (PMP) equipped with a mobile OS, a game console, a navigation device, an e-book reader, or the like. In addition, a variety of hardware modules may be installed in the mobile terminal 100. It will be understood that the following exemplary embodiments may be applicable to a fixed terminal that has a predetermined OS mounted and thus allows various programs to be installed and run thereon.

Referring to FIG. 1, the mobile device 100 includes a control unit 110 (e.g., a controller), an input unit 120 (e.g., an input receiver), a memory unit 130 (e.g., a memory), an output unit 140 (e.g., am output device), a communication unit 150 (e.g., a transceiver), a sensor unit 160 (e.g., a sensor), and a camera unit 170 (e.g., a camera). The control unit 110 includes a user verification module 112, and the input unit 120 includes a fingerprint reader 122. FIG. 1 shows an exemplary configuration of the mobile terminal 100 with the fingerprint reader 122. Thus, the aspects of the present embodiment may not necessarily include all functional units of the mobile device shown in FIG. 1, and may omit one or more functional units. For example, the mobile device 100 may not include the sensor unit 160 or the camera unit 170. Further, the mobile terminal 100 may additionally include other functional units to execute a particular operation. The added functional units may vary depending on type or function of the mobile device 100. For example, the mobile device 100 may further include a vibration module, a global position system (GPS) module, a digital multimedia broadcasting (DMB) module, a wired communication module (not shown).

The mobile device 100 may provide various functions by utilizing the above elements, and enable a user to utilize the mobile device 100 and the various mounted hardware modules. The mobile device 100 may have different types of applications installed therein. The applications may include applications initially installed by a manufacturer or a network service provider, and may include applications downloaded from an application market or the like and installed by the user.

The control unit 110 may execute overall management, processing, and control for operations of the mobile device 100. For example, the control unit 110 may perform control and signal processing for an operation to execute a predetermined functional module or an application within the mobile device 100. In addition, the control unit 110 may control the communication unit 150 to enable the mobile terminal 100 to execute data communication or voice/video call to communicate with a service provider or another mobile terminal, and may process transmitted and received signals. The control unit 110 may execute a predetermined operation in response to a visible, audible, or mechanical signal inputs from the input unit 120, the sensor unit 160, or the camera unit 170, and may control the output unit 140 to output a result of processing the input signal and/or a result of the control unit 110 executing the predetermined operation as a visible, audible, or mechanical signal. Further, the control unit 110 may store, in the memory unit 130, data received through the input unit 120 or the communication unit 150 and data generated by executing an application, and may execute general file management, such as open, an update, and the like, for files stored in the memory unit 130.

The control unit 110 may authenticate a user using a fingerprint reading by the fingerprint reader 122, and may control a signal processing process and elements for the user verification. More specifically, the control unit 110 may drive the fingerprint reader 122 to scan and read the fingerprint of the user, and may control the input unit 120 and the output unit 140 to provide an associated user interface (UI). Further, the control unit 110 may control the input unit 120 and the output unit 140 such that a user interface to register the user's fingerprint and a user interface to set a security level for each application can be provided. The control unit 110 may execute a request from the user, such as, unlocking, performing a function, or running an application, according to a fingerprint verification result, or may control the output unit 140 to output a warning message and/or a request to re-input the fingerprint to a user who was not authenticated successfully.

To this end, the control unit 110 may include a user verification module 112. The user verification module 112 may determine a matching value by comparing the fingerprint read by the fingerprint reader 122 with a registered fingerprint and may compare the determined matching value with a security level of an application requested to be run, and determine whether to run the application. Here, the matching value which is a type of information that indicates the degree of matching between two fingerprints may be represented as, for example, a percentage value. In addition, the security level as a criterion for determining whether to execute the associated application may vary depending on a form and/or a type of an application. The security level of each application may be previously specified by the user. The operation and configuration of the user verification module 112 will be described in more detail below.

The input unit 120 and the output unit 140 constitute a user interface of the mobile device 100. The input unit 120 is used to input user data, an input, an instruction, a request signal, and the like to the mobile device 100, and the output unit 140 is used to output data, information, and a signal processed by the mobile device 100. More specifically, the input unit 120 may include a microphone for voice or audio input, a key pad for the user to input data or instructions to the mobile device 100, a dome switch, buttons, a jog wheel, a touchpad, and the like. The output unit 140 may include a display to output an image signal or a video signal, audio output equipment, such as an ear jack and/or a speaker for an audio signal output, and a vibration module for generating a tactile signal (e.g., vibration) output.

In the present example, the input unit 120 may include the fingerprint reader 122. The fingerprint reader 122 is a module to scan a finger to read a fingerprint, and in this example, the fingerprint reader 122 is not limited to a specific type. The fingerprint reader 122 may recognize the scanned fingerprint through feature points of the fingerprint, or recognize the fingerprint as the scanned fingerprint image itself.

The mobile device 100 may include a touch screen. The touch screen is one type of user interface for interaction between the user and the mobile device 100. Further, the touch screen may operate as a touchpad of the input unit 120 as well as a display of the output unit 130. The touch screen may have a layered-structure in which a touchpad as an input interface is coupled to a display as an output interface, or have a structure in which the touchpad and the display are integrated into one combined structural unit. The user may input an instruction or information to the mobile device 100 by touching the touch screen manually or using a stylus when the touch screen is displaying the user interface. The mobile device 100 may output text, images, and/or video through the touch screen to the user.

In one aspect of the exemplary embodiment of the present invention, the control unit 110, particularly, the user verification module 112 may provide a user interface through the touch screen to assist the interaction of the mobile device 100 with the user to perform user verification through a fingerprint recognition. For example, the user verification module 112 may provide a user interface for recognizing the user's fingerprint, a user interface for the user's fingerprint registration, a user interface for setting a security level of each application, and the like, through the touch screen.

The memory unit 130 stores applications and data that may be utilized for operating the mobile device 100. More specifically, the memory unit 130 may store a variety of applications for processing and controlling, e.g., an OS program, a program for implementing a functional module, such as the user verification module 112, and applications. Further, the memory unit 130 may store data and information, such as emails, text, images, videos, documents, music, phone numbers, call history, and messages. The memory unit 130 is not limited to a specific type, and may include a random access memory (RAM), and include an embedded memory, flash memory including Universal Subscriber Identity Module (USIM) memory, magnetic disk memory, read only memory (ROM), and the like.

The memory unit 130 may store information to authenticate the user's fingerprint. For example, the memory unit 130 may store security level information in a security level database 132 regarding security levels of applications installed in the mobile device 100, and may store information on the user's fingerprint in a registered-fingerprint database 134. The security level database 132 and the registered-fingerprint database 134 will be described in more detail below.

The communication unit 150 is used for communication with a wireless communication network and/or another electronic device by transmitting and receiving electromagnetic waves, and may include a mobile communication unit for voice, image, and data communications in accordance with mobile communication standards, a Wi-Fi communication unit for wireless local area network (WLAN) communication, a near-field communication (NFC) communication unit for NFC communication. In the illustrated exemplary embodiment, the communication unit 150 may transmit, to the server, the information about the security level of an application which has been set by the user through a security level setting unit 1126. The sensor unit 160 may include a gravity sensor, a proximity sensor, an accelerometer sensor, a motion sensor, an illumination sensor, and the like. The camera unit 170 captures images and generates image/video signals.

Hereinafter, the user verification module 112 of the control unit 110 will be described in more detail. In one example, the user verification module 112 may include a fingerprint registration unit 1122, a fingerprint verification unit 1124, and the security level setting unit 1126. In this case, the configuration of the user verification module 112 is logically defined based on functions of the units. Therefore, the fingerprint registration unit 1122, the fingerprint verification unit 1124, and the security level setting unit 1126 may be implemented in a physically integrated single hardware component, e.g., a processor, or by incorporating any two of these units. For example, the fingerprint registration unit 1122 may be implemented as a functional unit included in the fingerprint verification unit 1124, or as a separate functional unit. The user verification module 112, particularly, the fingerprint registration unit 1122 and the fingerprint verification unit 1124, may be implemented as a single module by being integrated into the fingerprint reader 122, or implemented as separate individual functional modules.

The fingerprint registration unit 1122 is used to register the user's fingerprint that is recognized by the fingerprint reader 122. The fingerprint to be registered may be a fingerprint of a single user who is the owner of the mobile device 100 or one of fingerprints of multiple users if the mobile device 100 is allowed to be used by the authorized multiple users based on user accounts. The fingerprint registration unit 1122 may communicate with the memory unit 130 to store the registered fingerprint(s) in the memory unit 130, and the fingerprint(s) may be stored without limitation in terms of format. For example, the registered fingerprint may be stored in the memory unit 130 in a form of registered fingerprint DB 134. To enable the user to register a fingerprint, the fingerprint registration unit 1122 may control the input unit 120, particularly, the fingerprint reader 122, and also control the output unit 140 to provide a user interface for the registration.

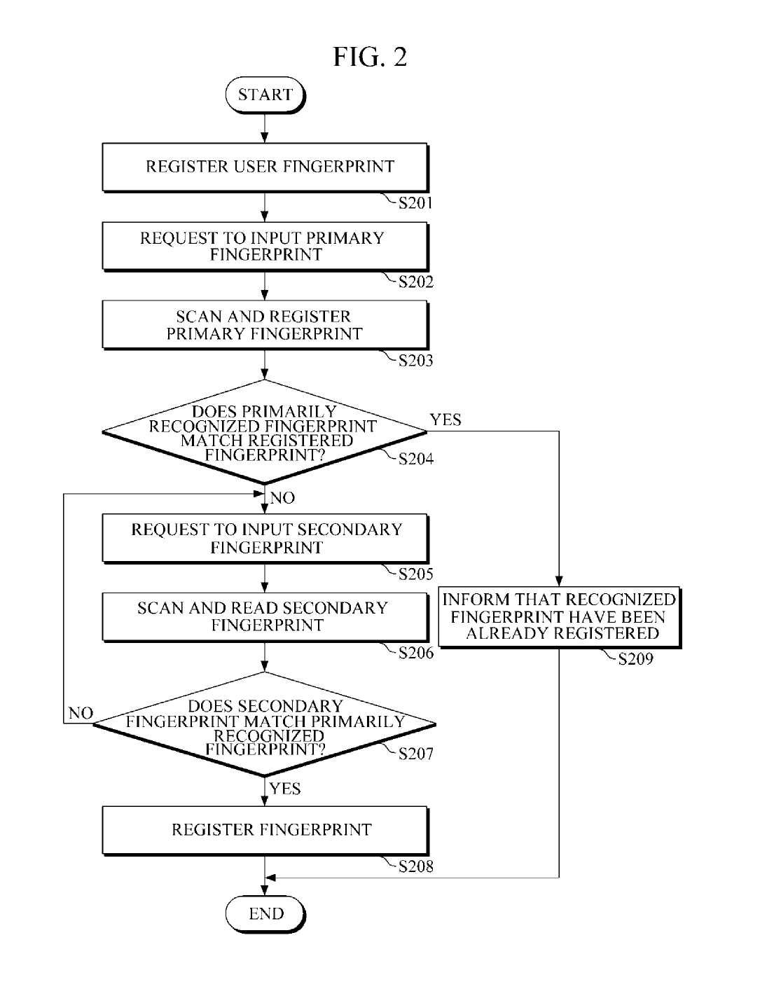

In the illustrated exemplary embodiment, there is no limitation for procedures of registering the fingerprint of the owner and/or the user of the mobile device 100 through the fingerprint registration unit 1122. More specifically, general fingerprint registration procedures executed by any type of devices (e.g., an entrance door, a safe, a user verification device connected to a computer, and the like) equipped with a fingerprint reader may be performed as the fingerprint registration procedures using the fingerprint registration unit 1122, with or without modifications in part. FIG. 2 illustrates an example of such fingerprint registration procedures. FIG. 2 is a flowchart illustrating an example of procedures of registering a user's fingerprint according to an exemplary embodiment of the present invention.

Referring to FIG. 1 and FIG. 2, in operation S201, user information is registered, such as a fingerprint of a user. To this end, a fingerprint recognition application installed in the mobile device 100 may be executed. Then, a fingerprint registration menu may be selected and run manually by the user or automatically upon the execution of the application. A user interface may be provided through a touch screen to allow a user to provide a fingerprint to authenticate him/herself as a previously registered user or to register as a new user. If the user is a previously registered user, the fingerprint of the user provided through the user interface may be authenticated by checking previously registered information or update or correct the information if necessary, or if the user is a new user, the user may input user information (e.g., user account information).

Once the user information registration is completed, the mobile device 100 outputs a message to request the user to input the primary fingerprint in operation S202. In this case, the message to be output is not limited to a specific type, format, or output method. For example, the mobile device 100 may output a message on a display to request the user to input a fingerprint or output the same message audibly using an audio output device or by other means. Further, a signal (e.g., light on a state indication lamp on the fingerprint reader, a vibration signal, and the like) to request the user to input the fingerprint using the fingerprint reader 122 may be output. The message may be output through at least one of the display and the audio output device along with the signal simultaneously or separately.

In operation S203, if a finger of the user is located in proximity to a fingerprint sensing interface of the fingerprint reader 122 (e.g., touching or sweeping the fingerprint reader 122 with a finger), the fingerprint is scanned and read to perform the primary fingerprint recognition process. For the fingerprint recognition, the fingerprint reader 122 may include a sensor to detect the approach or touch by a finger. When detecting the approach or touch of the finger, the control unit 110, specifically, the fingerprint registration unit 1122 may control the operation of the fingerprint reader 122 to scan and convert the fingerprint into an electric signal to be recognized.

In the illustrated exemplary embodiment, the fingerprint reader 122 is not limited to a specific method or algorithm to recognize a fingerprint, and any existing algorithms or future algorithms to be practically applied to products may be incorporated. The fingerprint reader 122 may extract a number of feature points from a scanned fingerprint image, and recognize the fingerprint based on the feature points. Here, the feature points refer to minutiae, which include a ridge ending and a ridge bifurcation. The number of feature points may be an example of an authentication parameter used in the authentication of the fingerprint. Further, the fingerprint reader 122 may recognize the scanned fingerprint and the entire pattern of ridges as an image.

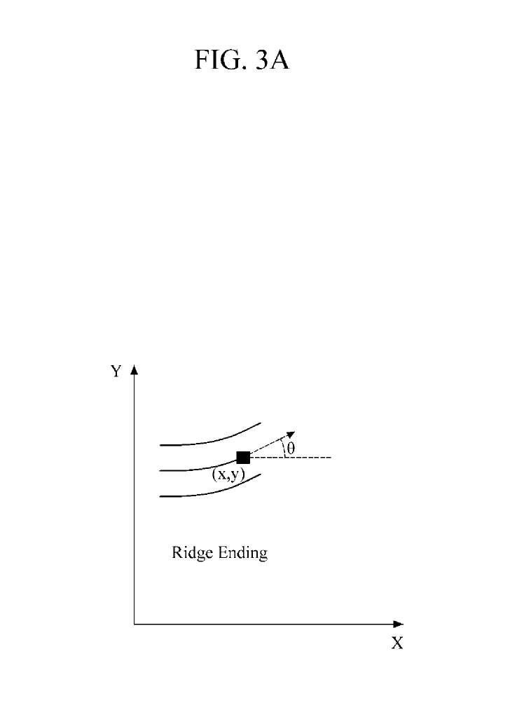

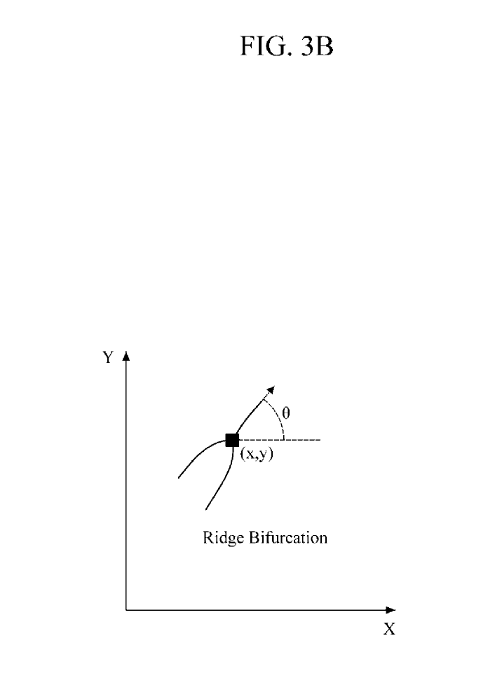

FIG. 3A is a diagram illustrating a ridge ending of a fingerprint, and FIG. 3B is a diagram illustrating a ridge bifurcation of a fingerprint. Referring to FIG. 3A, the ridge ending is a point where a ridge (a line that forms a fingerprint) of a fingerprint ends. The ridge ending is specified using other authentication parameters, e.g., a position (x, y) and an orientation (θ). The position (x, y) and the orientation (θ) may be more significant in relation to a relative position of another feature point and such information may be considered as another authentication parameter. Referring to FIG. 3B, the ridge bifurcation is a point where at which a single ridge splits into two ridges or two ridges are combined into one. The ridge bifurcation is specified using a position (x, y) and an orientation (θ).

Referring back to FIG. 2, if the fingerprint recognition is completed, the fingerprint registration unit 1122 may determine whether the recognized fingerprint matches one of the registered fingerprints in operation S204. In this case, there is not a specific limitation in determining a criterion for determining whether the two fingerprints match each other. For example, it may be determined that the recognized fingerprint matches the registered fingerprint if a matching value between the two fingerprints is greater than a predetermined value (e.g., 90%). In the process of a fingerprint registration, the matching value used as a criterion for determination of matching between two fingerprints may be a value as close as possible to 100%. A method of calculating the matching value may be determined according to a fingerprint recognition algorithm. For example, the matching value may be calculated as a ratio of the number of matching feature points to the number of all fingerprints, which are utilized for fingerprint recognition. Further, the matching value may be calculated by arithmetically calculating a degree of matching between two fingerprint images using an image interpretation program with a predetermined algorithm. The matching value described herein may be used an authentication parameter in authenticating a recognized fingerprint.

The determination operation may be performed not by the fingerprint registration unit 1122, but by the fingerprint verification unit 1124, and the fingerprint registration unit 1122 may simply receive the determination result from the fingerprint verification unit 1124. Also, the registered fingerprint may have been previously registered in the registered fingerprint DB 134 of the memory unit 130 by the same user. Thus, if it is determined that the recognized fingerprint is the same as an already registered fingerprint of the same user (in the operation S204), the operation flow may be terminated after informing the determination result in operation S209. Therefore, it may be possible to simplify the fingerprint registration procedures of FIG. 2. Even in a case where the user whose information has been registered in the operation S201 is a new user attempting to register a fingerprint for the first time in the mobile device 100 or a previously registered user, it may be possible to omit the operation S204 and the following operation S209 if the user deletes the registered fingerprint and attempts to register a new fingerprint (or if the fingerprint registration process is based on an algorithm according to a latter scheme).

Thus, in a case where it is determined, in the operation S204, that the recognized fingerprint does not match the registered fingerprint or in a case where the operation S204 is not performed, the mobile device 100 outputs a message to request the user to input a fingerprint again in operation S205 after the fingerprint recognition is completed in the S203. The output message may be of the same type, format or output method as that performed in the operation S202, but aspects are not limited thereto. Further, a signal to request the user to input a fingerprint using the fingerprint reader 122 may be output along with the message.

In response to the user's approaching, touching, or sweeping of the finger on the fingerprint reader 122, the fingerprint is scanned and read to perform a secondary fingerprint recognition process in operation S206. A method or algorithm of the fingerprint reader 122 to recognize the fingerprint may be the same as that used in the operation S203. Once the secondary fingerprint recognition is completed, the fingerprint registration unit 1122 determines, in operation S207, whether the fingerprint recognized in the operation S206 matches the fingerprint registered in the operation S203. A criterion for determining whether the two fingerprints match each other may vary, or the same criterion utilized in the operation S204 may be applied. The determination may not be performed by the fingerprint registration unit 1122, but by the fingerprint verification unit 1124, and the fingerprint registration unit 1122 may receive the determination result from the fingerprint verification unit 1124 for processing the result.

In response to a determination that the fingerprint secondarily recognized in the operation S206 is identical to the fingerprint primarily recognized in the operation S203, the fingerprint registration unit 112 registers the user's fingerprint and stores it in the registered fingerprint DB 134 of the memory unit 130 in operation S208. If the two fingerprints are not identical or the matching ratio is lower than a threshold matching ratio, either the fingerprint primarily recognized in the operation S203 or the fingerprint secondarily recognized in the operation S206 may be registered in the operation S208. In response to a determination, in the operation S207, that the two fingerprints are not identical, the process may return to the is operation S205. In this case, the number of repetitions of the operations S205, S206, and S207 the operations S205, S206, and S207 may be e.g., 2 to 4, but is not limited as such. Although not illustrated, before repeating operation S205, a notification message or an alarm message may be output through the output unit 140 to indicate that the two fingerprints are not identical.

Referring back to FIG. 1, the fingerprint verification unit 1124 may calculate the matching value by comparing the fingerprint recognized by the fingerprint reader 122 and the user fingerprint stored in the registered fingerprint DB 134 of the memory unit 130. The fingerprint verification unit 1124 may not be limited to a specific algorithm to calculate the matching value between the two fingerprints. For example, the matching value may be calculated as a ratio of the number of identical feature points (the number of feature points of the recognized fingerprint to be authenticated that have the same position and orientation as those of the corresponding feature points of the registered fingerprint) between the two fingerprints to the number of all feature points (the number of feature points of the registered user fingerprint). Further, the matching value may be calculated by arithmetically calculating a degree of matching between the two fingerprint images using an image interpretation program. For example, the entire fingerprint image may be partitioned into multiple image blocks, and a ratio of the blocks including the identical fingerprint images to the number of all blocks may be obtained as the matching value. The size of the image block and the number of the image blocks may be used as authentication parameters.

Further, the fingerprint verification unit 1124 may determine whether to permit the execution of the requested application by comparing the calculated matching value with the security level of the application. For example, the fingerprint verification unit 1124 may allow for the execution of the application only when the calculated matching value corresponds to the set security level of the application or is higher than the security level. In the illustrated exemplary embodiment, the security level of each application may be previously set by the user or be specified by a separate application for user and/or fingerprint verification, according to predefined criteria or factors, which will be described below.

The fingerprint verification process by the fingerprint verification unit 1124 (including the fingerprint recognition process by the fingerprint reader 122) may be performed after receiving a request for executing an application. That is, in response to an event to request to run a particular application in the mobile device 100, the fingerprint verification unit 1124 may control the fingerprint reader 122 to recognize the fingerprint and then the recognized fingerprint is verified. The fingerprint recognition process by the fingerprint verification unit 1124 may be performed while a separate application for fingerprint verification is being run. Further, regardless of the request to run a particular application, the fingerprint verification unit 1124 may perform the fingerprint recognition process first. In this case, a list or icons of applications that are permitted to be run may be shown on a display according to the fingerprint verification result of the fingerprint verification unit 1124.

Here, the “applications” refer to all or a portion of applications installed in the mobile device 100 and/or particular applications with a security level set by the user. In the latter case, the “applications” may refer to applications that have the security level set or some applications, among the application with the security level set, that are set to be subject to a verification process as a prerequisite for execution of the applications.

The “request to run an application” may include not only a case where the user manually inputs an instruction to request to run the application (for example, touches an icon of the application on the touch screen) but also a case where the control unit 110 of the mobile device 100 generates an execution request event with respect to the particular application in association with the execution of another application. In addition, the “request to run an application” may include a request to run an application installed in the mobile device 100, a request to execute a particular function of the mobile device 100, and a request to unlock the mobile device 100, as described above.

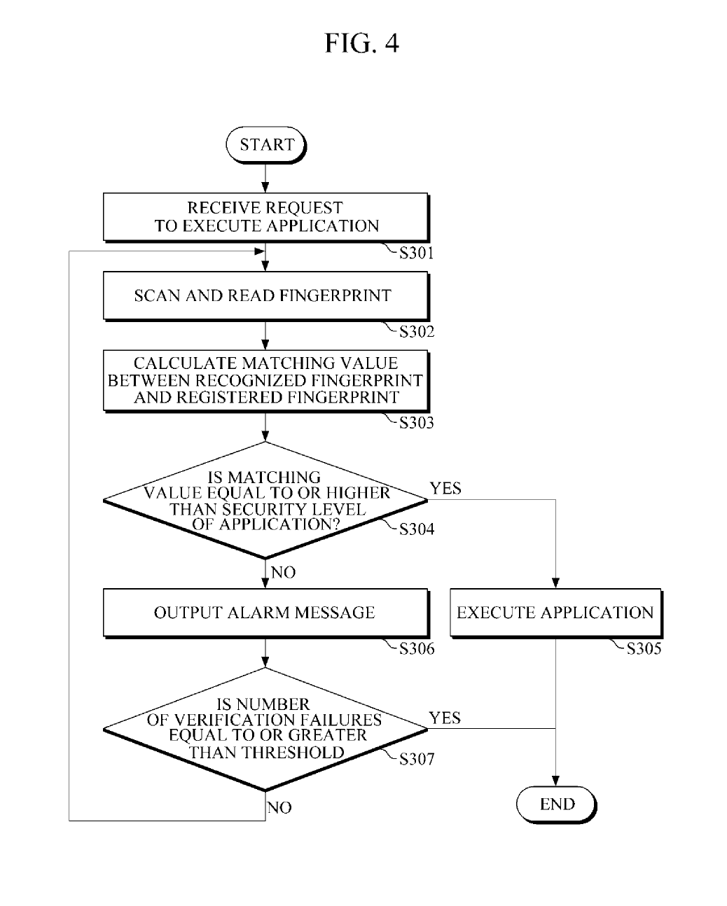

FIG. 4 is a flowchart illustrating user verification procedures according to an exemplary embodiment of the present invention. The user verification procedures of FIG. 4 may be performed by the control unit 110 of the mobile device 100 of FIG. 1, specifically, by the user verification module 112 including the fingerprint verification unit 1124. Herein, the user verification procedures will be described with reference to FIGS. 1 and 4. Hence, it is understood that the description with respect to the user verification module 112 and/or the fingerprint verification unit 1124 may be applied to operations which are not described herein in detail.

Referring to FIG. 1 and FIG. 4, in operation S301, a request to run an application is received. In this operation, the request may be explicitly input by the user, or may be an application running event that occurs according to a processing result (e.g., launching an application associated with a currently executed application) of the control unit 110 of the mobile device 100.

In response to the request to run an application, the fingerprint verification unit 1124 controls the fingerprint reader 122 to recognize the fingerprint of the user by scanning and reading it in operation S302. To this end, the output unit 140 and/or the fingerprint reader 122 may provide a predetermined user interface and/or a signal to the user, as described above. If the use of the mobile device 100 is allowed to multiple users (e.g., multiple users are registered with their own unique user accounts), an operation for specifying a user who is subject to a fingerprint verification may be additionally performed prior to or subsequent to the operation S302 for scanning the fingerprint. Moreover, as described above, operation S301 and operation S302 may be performed in a different order such that the operation S302 is performed before the operation S301.

In operation S303, The fingerprint verification unit 1124 calculates a matching value by comparing the fingerprint recognized in the operation S302 and a previously registered fingerprint. The matching value may be calculated based on a ratio of the number of feature points identical between the two fingerprints to the number of all feature points of the registered fingerprint, or a ratio of the area identical between the two fingerprints to the entire area of the registered fingerprint.

In operation S304, the fingerprint verification unit 1124 determines whether the matching value calculated in the operation S303 is higher than a security level of the application requested in the operation S301. A security level may be previously set for each application or for each type of applications and/or set by the user, which will be described below. A type of an application may be a defined factor that varies one or more authentication parameters in authenticating a recognized fingerprint. In response to a determination that the matching value is higher than the security level, the fingerprint verification unit 1124 controls the application to be executed in operation S305.

In response to a determination that the matching value is lower than the security level, the fingerprint verification unit 1124 controls the output unit 140 to output an alarm message to indicate a verification failure in operation S306. In another example, the fingerprint verification unit 1124 may control the output unit 140 to output a message simultaneously or sequentially with the alarm message, to request the user to determine whether to perform the fingerprint verification process again.

In operation S307, it may be determined whether the number of fingerprint verification failures exceeds a maximum failure threshold. In response to a determination that the number of fingerprint verification failures is smaller than the maximum failure threshold, the process returns to the operation S302. In response to a determination that the number of fingerprint verification failures is equal to or greater than the maximum failure threshold, the fingerprint verification unit 1124 may terminate the user verification process. In this case, the fingerprint verification unit 1124 may control the output unit 140 to output an alarm message to notify that the fingerprint verification process is terminated.

Referring back to FIG. 1, the security level setting unit 1126 is to set a security level of an application of the mobile device 100. Here, the “application of the mobile device 100” as a target of the security level setting may not be limited to applications installed in the mobile device 100. For example, functions that can be provided to the user through a hardware module or a software module mounted in the mobile device 100 by executing the installed application or regardless of an execution of the application, or functions, such as unlocking, that require user verification for use or execution of the mobile device 100 may be included in the “application of the mobile device 100.”

The “security level” refers to a condition for allowing the execution of the requested application of the mobile device 100. In one example, the security level may be a value that indicates a degree of matching between a fingerprint of the user newly recognized by the fingerprint reader 122 and a previously registered fingerprint of the same user before or after the request for executing an application (in this case, a degree of mismatching between the two fingerprints can also be used according to a configuration). Unlike conventional user verification devices, it may be possible for the user to set the security level for each application or each group of applications (e.g., each type of application) according to exemplary embodiment of the present invention.

To assist in setting the security level, the security level setting unit 1126 may provide a predetermined user interface through the input unit 120 and the output unit 140 of the mobile device 100. The user may set the security level on an application-by-application basis or on an application group-by-application group basis (e.g., type of application), using the provided user interface. Further, the security level set for each application or each group of applications may be manually changed by the user. A defined application group may be a defined factor that affects the fingerprint authentication. For example, one or more authentication parameters may be changed in the authentication process. The security level set for each application or each group of applications may be stored in the memory unit 130 of the mobile device 100 or a designated server (e.g., an application market), so that, even when the user deletes and re-installs an application, the security level that has been previously set for the application can be applied to the user verification process.

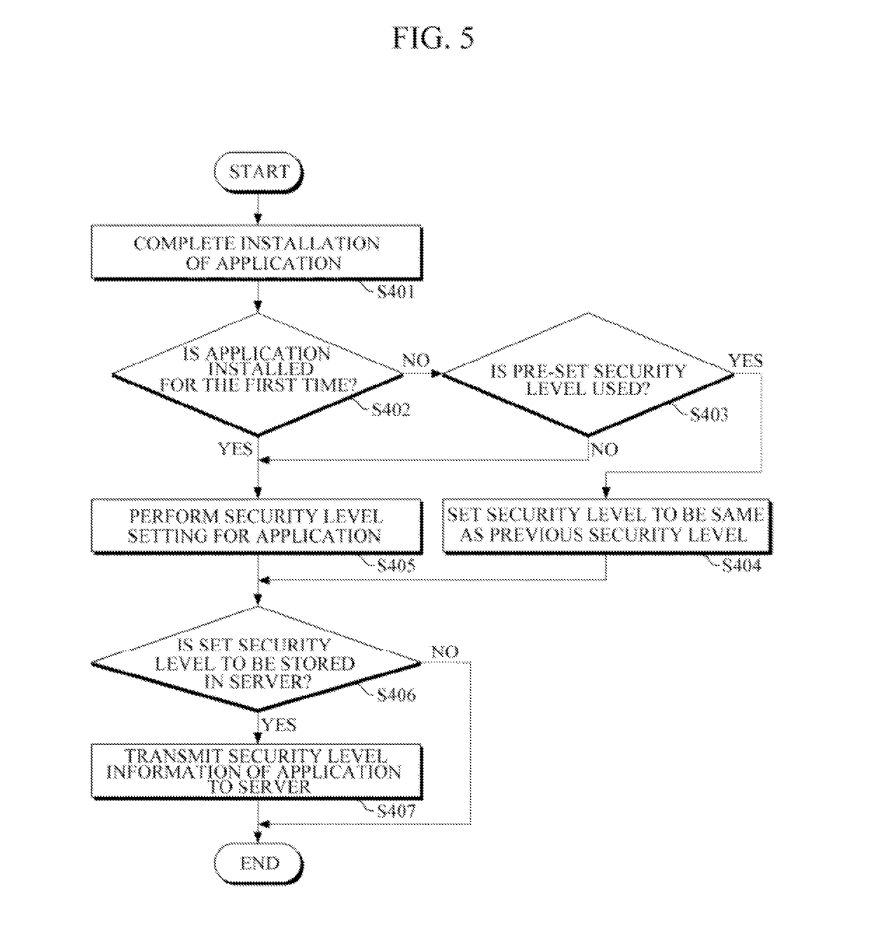

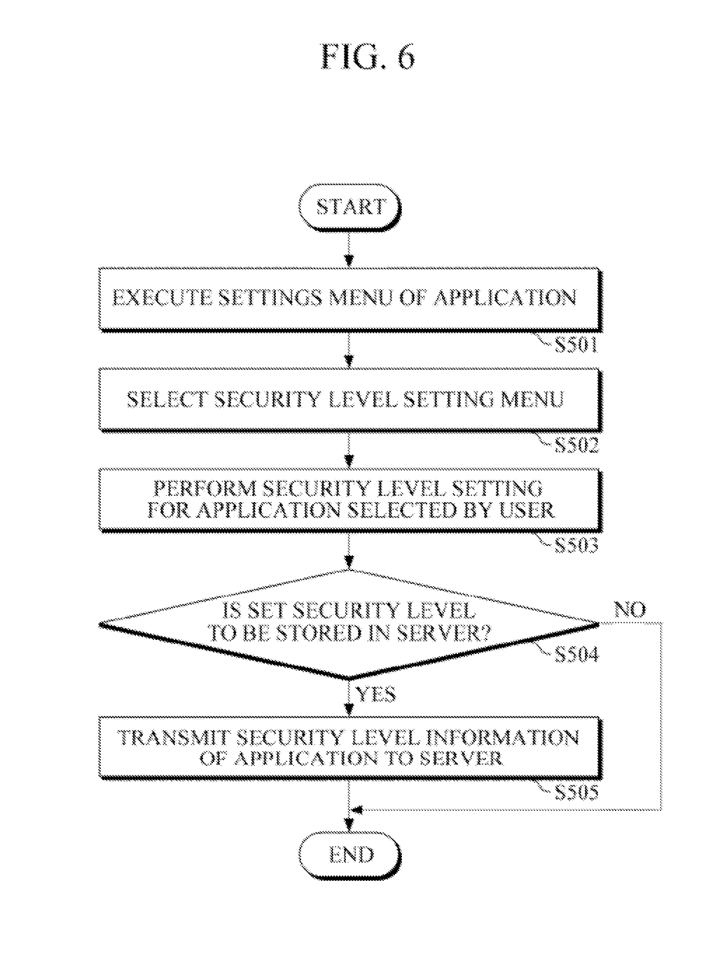

Hereinafter, when the security level setting unit 1126 sets the security level of the application (including changing of the previously set security level) will be described. For example, the security level setting unit 1126 may proceed to the security level setting process immediately after a new application is installed in the mobile device 100 (See e.g., FIG. 5). Further, when a separate menu to provide a function for setting a security level of an application (e.g., in a case where a settings application provides a security level setting menu in accordance with an exemplary embodiment) or a separate application (e.g., in a case where a security level setting menu of a user verification application based on fingerprint verification is selected) is executed, the security level setting unit 1126 may proceed to security level setting process to select, from among applications of the mobile device 100, intended target application for security level setting and set a security level of the selected application (See e.g., FIG. 6).

FIG. 5 illustrates a security level setting procedure after a new application has been installed in a mobile device according to an exemplary embodiment of the present invention, and FIG. 6 illustrates a security level setting procedure by setting a security level setting menu provided by a settings application installed in a mobile device according to an exemplary embodiment of the present invention.

A level setting procedure will be described with reference to FIG. 1 and FIG. 5.

Referring to FIG. 1 and FIG. 5, the installation of the application in the mobile device 100 is completed in operation S401. The cause or method of the installation of an application in the mobile device 100 may vary. In addition, the application to be installed in the mobile device 100 may include, without limitation, an application that is installed for the first time in the mobile device 100, a previously installed application to be updated, and an application to be re-installed after uninstallation.

In operation S402, it is determined whether the application that has been completely installed in the mobile device 100 in the operation S401 is an application that has never been installed before. In response to a determination that the application has been installed before (which includes updating of the installed application and reinstalling of a newer version of the installed application), a message that inquires the user whether to use the previously set security level intact is output in operation S403. In response to receiving an input from the user that indicates the use of the previous security level, the security level of the application is set to be the same as the previous security level in operation S404. After completing the operation S404, operation S406 and/or operation S407 may be performed, or the security level setting process may be terminated (not illustrated). In response to receiving a response that indicates that the user does not use the previous security level as determined in the operation S403, a security level setting for the application may be performed in operation S405.

Regardless of the determination in the operation S402, the operation S403 may be performed. In this case, if an input that indicates that the user does not intend to use the previously set security level is received in the operation S403, the security level setting unit 1126 performs security level setting process for the installed application in the operation S405. To this end, the security level setting unit 1126 may provide a predetermined user interface to enable the user to input an intended security level, and store the input security level in the security level database 132 of the memory unit 130.

In response to storing the set security level in the security level DB 132, the security level setting unit 1126 may output a message to inquire the user to store the security level in the server or other storage device, or a memory in the mobile device 100 in the operation S406. In some cases, operation S406 may be performed after performing the operation S404 when the previously set security level for the application has not been registered in the server. Here, the server may be a server of a service provider, such as an application market, that offers an application download service based on a registered user account. In response to receiving an input from the user that indicates the storing of the set security level in the server, the mobile device 100 controls the communication unit 150 to transmit information about the set security level to the server such that the security level can be stored in the server in operation S407. Further, in response to an input from the user that indicates that the set security level is not stored in the server, the operation is terminated without performing operation S407.

As such, the security level setting procedure of FIG. 5 is performed based on whether the currently installed application has never been installed before or not. However, the security level setting procedure of FIG. 5 may be applied based on whether a currently installed application is set to a default security level or not. In this case, the application may be installed in the mobile device 100 for the first time, but the type of application is not limited thereto. Further, the “default security level” may be set by an application developer, or by a service provider that offers an application download service, and/or all applications of the mobile device 100 may have the same security level.

For example, in the security level setting procedure illustrated in FIG. 5, specifically, operations S402 to S404, may be modified and performed as below. In S402, it may be determined whether the installed application has a default security level (if the same security level is set for all applications of each mobile device, this operation may be omitted). If the default security level is set, a message may be output to inquire the user whether to use the default security level intact in operation S403. In response to an input from the user that confirms the use of the default security level without modification, the security level of the application is set to be the same as the default security level in operation S404. Operation S405 may be performed in response to receiving a determination of the operation S402 that the application does not have a default security level, or in response to receiving an input that indicates that the user does not use the default security level.

Hereinafter, a security level setting procedure according to another exemplary embodiment will be described with reference to FIG. 1 and FIG. 6.

Referring to FIG. 1 and FIG. 6, in S501, a setting application is executed from among applications installed in the mobile device 100. In this example, the user who executes a setting menu is not limited to a specific method. For example, the user may touch a setting icon or click the lower right button on an Android® mobile device to select the settings menu. In the example, when the user executes the settings application in operation S501, the user verification procedures (See e.g., FIG. 4) may be performed. However, the descriptions thereof will not be repeated to avoid unnecessary repetition of the descriptions.

In response to executing the settings application in the operation S501, the user selects a security level setting menu from various provided menus in operation S502. In response to the user's selection of the security level setting menu, the security level setting unit 1126 may perform a security level setting procedure with respect to the application selected by the user in operation S503. The security level setting unit 1126 may provide a predetermined user interface to enable the user to input an intended security level, and store the input security level in the security level DB 132 of the memory unit 130. Here, the target application may be an application that is installed in the mobile device 100 for the first time or an application whose previously set security level is changed. In the latter case, the security level may have been previously set by the user or may be a default security level associated with the target application.

In response to storing the set security level in the security level DB 132, the security level setting unit 1126 may output a message to inquire the user whether to store the set security level in the server in operation S504. Here, the server may be a server of a service provider, such as an application market, that offers an application download service based on a registered user account. In response to an input from the user informing that the set security level is stored in the server, the mobile device 100 controls the communication unit 150 to transmit information about the security level set for the application to the server such that the security level is stored in the server in operation S505. In response to an input from the user informing that the set security level is not to be stored in the server, the operation is terminated without proceeding to the operation S505.

Referring back to FIG. 1, the security setting unit 1126 may store the information about the set security level in the memory unit 130. The storage of the information about the security level is not limited to a specific method or format. For example, as shown in FIG. 1 to FIG. 7B, the information may be stored in the form of a security level DB 132. The security level DB 132 may be located in the memory unit 130 and may be a reference for verifying a fingerprint with respect to an application. More specifically, it may be a reference for determining whether a matching value between a newly recognized fingerprint and the registered fingerprint is equal to or higher than a security level of the requested application. According to an aspect, the information about the security level may not be stored in a separate database, but may be stored as a part of information about each application.

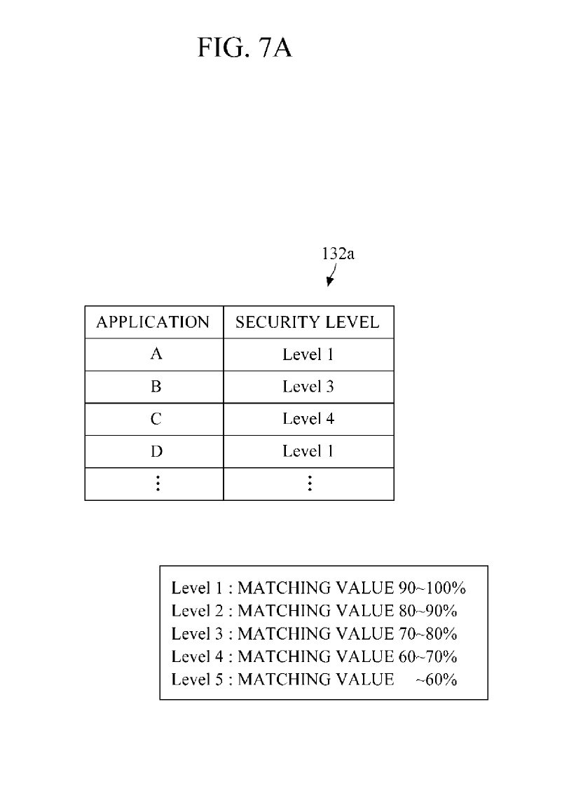

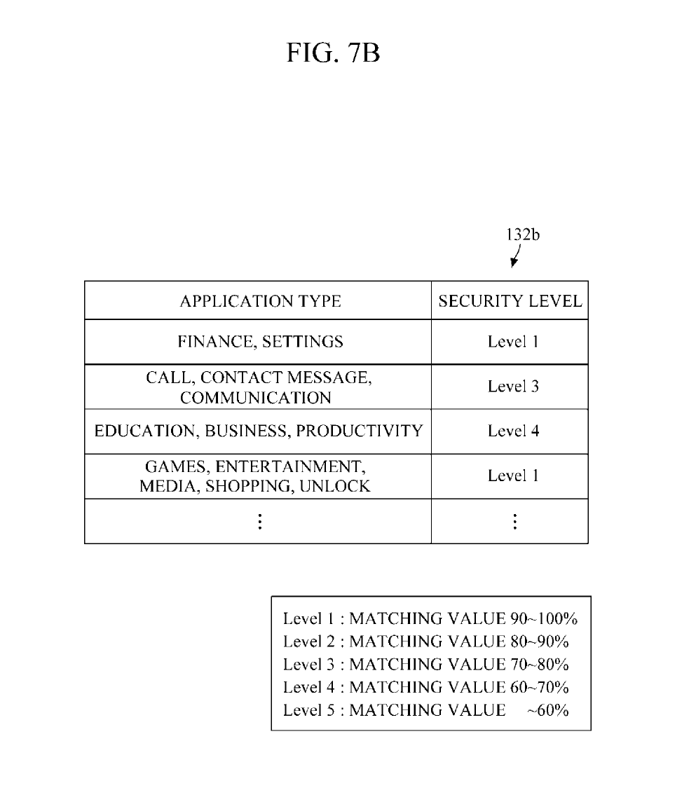

FIG. 7A and FIG. 7B are diagrams illustrating examples of security level DBs stored in a memory unit, e.g., the memory unit 130 of FIG. 1. FIG. 7A illustrates a security level DB 132a when a security level is set on an application-by-application basis. FIG. 7B illustrates a security level DB 132b when a security level is set on an application type-by-application type basis. The security level DB may be made only for applications of which security level has been previously set, but aspects are not limited as such. However, if a security level is set for each application, the security level DB may be built with respect to either all or some of applications. According to the latter case, a default security level may be changed by a user, and in this case, an application of which security level is not stored in the security level DB may be regarded as having a default security level.

In FIG. 7A and FIG. 7B, each of the security levels for individual applications or application types is set as a range of a matching value (e.g., one of Level 1 to Level 4), for example. Further, the security level may not be set as a range of a matching value, but as a minimum value, which is a threshold of a matching value for authenticated use verification. In this case, if the matching value calculated by the fingerprint verification unit 1124 is greater than the threshold, the user can be verified as an authenticated user.

In one aspect, the user may set a security level to one of levels, Level 1 to Level 4, through the security level setting unit 1126, according to application or application type. In this case, the security level of each application stored in the security level DB 132a or 132b may be different from that shown in FIG. 7A and FIG. 7B. In an example, the user may determine a security level for a different application type in the security level DB 132b. FIG. 7B shows that a communication type including “call,” “contacts,” “message,” and “communication” have the same security level, Level 3, but only some of them may have the same security level, Level 3, and the rest may have a different security level, for example, Level 1, Level 2, or Level 4.

In one aspect, an application may have two or more security levels. The security level of an application may vary depending on defined circumstantial factors. More specifically, the security level may be set differently according to time and/or location. For example, a security level may be set to a relatively low level in places, such as a school or home, where the user is usually located, and be set to a higher level in the other places. In another example, the security level may be set to a relatively low level during a particular time period in which the user frequently uses the mobile device 100 and/or a particular application. The change of a security level according to the circumstantial factors may be equally applied for all applications or selectively applied for only some applications, e.g., applications having a higher security level.

As described above, according to the exemplary embodiments, a security level for user verification may vary according to a type of application and/or circumstantial factors. The security level may be set by a user. For example, the user may set a relatively high security level for applications that are closely related with the security of the mobile device 100 (e.g., applications associated with settings or contact information, finance-related applications, or the like), and may set a relatively low security level for applications that are irrelevant or less relevant to the security of the mobile device 100 (e.g., game or multimedia playback applications, etc.). Generally, the higher the security level is, the higher the false rejection rate (FRR) is and the lower the false acceptance rate (FAR) is. On the other hand, the lower the security level is, the lower the FRR is and the higher the FAR is. Here, the FRR is the probability that a user is rejected to be verified with the user's own registered fingerprint, and the FAR is the probability that a non-registered person is falsely verified with the registered user's registered fingerprint. The false rejection occurs when the registered user's fingerprint is rejected in the fingerprint authentication process, and the false acceptance occurs when a non-registered user's finger print is accepted in the fingerprint authentication process.

As described above, it may be possible to solve the problems caused when a security level is set uniformly for all applications installed in a mobile device. More specifically, due to the nature of various circumstances in using the mobile device, the correctness of fingerprint recognition by use of a fingerprint reader equipped in the mobile device may vary according to the environment where the user is situated or the method how the user uses the mobile device. If all applications are set with high security levels, the user may have difficulties in executing an application even with a low security requirement since the probability that the security verification fails is increased due to the high security levels. On the other hand, if all applications are set with low security levels to avoid such problems, the security of applications requiring high level of security cannot be ensured. Thus, if the security levels are allowed to be differently set for individual applications or individual application types as described above, each application can be set with an appropriate security level by reflecting the relevance of the application with security. Further, the user may be allowed to set the security level, so that the security level can be adaptively set for each application according to the user's decision. Moreover, the security level may be set differently according to the circumstantial factors, so that user convenience can be satisfied in a relatively safe environment for the user and the security of an application can be strengthened in a relatively less safe environment for the user (time and/or place).

According to aspects, various finger print scanning configurations can be used, such as an optical scanner and a capacitive scanner, but aspects are not limited thereto. A capacitive scanner may be disposed along with a touch screen display such that a portion of the touch screen display serves as a fingerprint scanner.

As described above, the mobile device 100 may identify a first portion of a user's fingerprint, which may correspond to a portion of a registered fingerprint. If the first portion includes a certain number of feature points, such as a ridge end and bifurcation, and the like, the mobile device 100 may determine whether the number of feature points included in the first portion is greater than or equal to a threshold value. If the number of feature points included in the first portion is greater than or equal to a threshold value, the mobile device 100 may determine whether the relative positions of the feature points in the recognized fingerprint are matched with the relative positions of the feature points in the registered fingerprint or may calculate a matching ratio based on the relative positions of the feature points. Along with the relative positions, other parameters, such as a ridge angle or a bifurcation angle illustrated in FIG. 3A and FIG. 3B may be used to calculate the matching. Based on the matching determination or the matching ratio, the mobile device 100 may authenticate the user who touches the fingerprint scanner on the mobile device 100.

If the first portion does not include enough information to authenticate the user, the mobile device 100 may have the user to rescan the finger of the user. The mobile device 100 may display which portion of the finger has been scanned and/or which portion of the finger has not been scanned such that the user can touch the fingerprint scanner by non-scanned portion of the finger. If a second portion of the user's fingerprint is scanned, the previously scanned first portion may be used along with the second portion to authenticate the user. Accordingly, the mobile device 100 may avoid continuous rescan of the entire fingerprint when the user is situated in an environment in which the user cannot focus on the fingerprint scanning process (e.g., when the user is driving a car).

The minimum number of feature points included in a portion of a fingerprint obtained in each scanning process and the number of portions of the fingerprint may be set dynamically depending on the various factors described above, e.g., time, location, application type, and the like.

Further, if the mobile device 100 is communicated with a registered pair device, such as a smart watch or a smart vehicle, which are configured to communicate with the mobile device 100 via a wireless communication and registered as a pair device of the mobile device 100, the fingerprint authentication process may be less strictly performed as described above. Further, according to defined factors, the number of fingers to be authenticated may be determined. For example, if a secure authentication is required, the authentication process may require two or more fingers to be authenticated.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method that uses a processor to control a fingerprint authentication operation of a mobile device, the method comprising:
recognizing a fingerprint if an object touches a designated location of the mobile device;
determining one or more authentication parameters to authenticate the recognized fingerprint, the one or more authentication parameters being varied according to one or more defined factors;
retrieving a registered fingerprint to authenticate the recognized fingerprint; and
authenticating, using the processor, the recognized the fingerprint based on the one or more authentication parameters.

2. The method of claim 1, wherein the one or more authentication parameters comprises at least one of a characteristic of a feature point of a fingerprint, a number of feature points, and an image block of a fingerprint.

3. The method of claim 1, wherein the one or more defined factors comprises at least one of a time and a location of the mobile device.

4. The method of claim 1, further comprising:
comparing the registered fingerprint with the recognized fingerprint based on one or more feature points of the registered fingerprint and the recognized fingerprint.

5. The method of claim 1, further comprising:
receiving an input to perform an operation of an application; and
determining an authentication factor based on a type of the application or a type of the operation of the application.

6. The method of claim 1, further comprising:
providing a user interface to set an authentication parameter.

7. The method of claim 6, further comprising:
providing a user interface to define a factor to control the authentication parameter.

8. The method of claim 1, further comprising:
grouping applications according to each application type,
wherein each application group corresponds to a security level.

9. The method of claim 8, wherein the security level is associated with the one or more parameters.

10. The method of claim 1, wherein each application is assigned a security level.

11. A mobile device to control a fingerprint authentication operation, the mobile device comprising:
a fingerprint reader to recognize a fingerprint if an object touches a designated location of the mobile device; and
a processor to determine one or more authentication parameters to authenticate the recognized fingerprint, the one or more authentication parameters being varied according to one or more defined factors, to retrieve a registered fingerprint to authenticate the recognized fingerprint, and to authenticate the recognized the fingerprint based on the one or more authentication parameters.

12. The mobile device of claim 11, wherein the one or more authentication parameters comprises at least one of a characteristic of a feature point of a fingerprint, a number of feature points, and an image block of a fingerprint.

13. The mobile device of claim 11, wherein the one or more defined factors comprises at least one of a time and a location of the mobile device.

14. The mobile device of claim 11, wherein the processor compares the registered fingerprint with the recognized fingerprint based on one or more feature points of the registered fingerprint and the recognized fingerprint.

15. The mobile device of claim 11, further comprising:
a user interface to receive an input to perform an operation of an application,
wherein the processor determines an authentication factor based on a type of the application or a type of the operation of the application.

16. The mobile device of claim 11, further comprising:
a user interface to set an authentication parameter.

17. The mobile device of claim 11, further comprising:
a user interface to define a factor to control the authentication parameter.

18. The mobile device of claim 11, wherein the processor groups applications according to each application type,
wherein each application group corresponds to a security level.

19. The mobile device of claim 18, wherein the security level is associated with the one or more parameters.

20. A non-transitory computer-readable storage medium having stored thereon computer executable instructions for authentication of a fingerprint, the stored computer executable instructions configured to cause a processor to perform processes comprising:
recognizing a fingerprint if an object touches a designated location of the mobile device;
determining one or more authentication parameters to authenticate the recognized fingerprint, the one or more authentication parameters being varied according to one or more defined factors;
retrieving a registered fingerprint to authenticate the recognized fingerprint; and
authenticating, using the processor, the recognized the fingerprint based on the one or more authentication parameters.
